(19) United States
(12) Patent Application Publication
(10) Pub. No.: US 2025/0357504 A1
(43) Pub. Date: Nov. 20, 2025

(54) UNIT FUEL CELL WITH COOLANT LEAKAGE PREVENTION STRUCTURE AND FUEL CELL STACK INCLUDING SAME

(71) Applicants: Hyundai Motor Company, Seoul (KR); Kia Corporation, Seoul (KR)

(72) Inventors: Hee Won Koo, Seoul (KR); Joon Hwan Kim, Seoul (KR)

(21) Appl. No.: 18/923,497

(22) Filed: Oct. 22, 2024

(30) Foreign Application Priority Data
May 17, 2024 (KR) 10-2024-0064257

(51) Int. Cl. H01M 8/0267; H01M 8/0228; H01M 8/0258; H01M 8/04029; H01M 8/04746; H01M 8/1004

(52) U.S. Cl. CPC H01M 8/0267; H01M 8/0228; H01M 8/0258; H01M 8/04029; H01M 8/04768; H01M 8/1004

(57) ABSTRACT

A fuel cell system includes a fuel cell stack with multiple unit fuel cells, each comprising a membrane-electrode assembly and separators. The unit fuel cells are equipped with coolant flow paths and coolant recovery flow paths, which penetrate both the membrane-electrode assembly and separators. The recovery flow paths are spaced apart from the coolant flow paths and are connected to a coolant reservoir to collect leaked coolant. The system also features valves that control the flow of coolant through the recovery paths, operating in a closed mode during operation and switching to an open mode when the fuel cell stack is not in use, allowing the discharge of collected coolant. Additional features include a hydrophobic coating on the separators, bridge flow paths between recovery paths, and inclined recovery paths to facilitate coolant movement by gravity.

### CROSS-REFERENCE TO RELATED APPLICATION

This application claims, under 35 U.S.C. § 119 (a), the benefit of Korean Patent Application No. 10-2024-0064257, filed on May 17, 2024, the entire contents of which are incorporated herein by reference.

### BACKGROUND

### Technical Field

The present disclosure relates to a unit fuel cell with a coolant leakage prevention structure and a fuel cell stack including the same, and more particularly to a unit fuel cell, which has an airtight structure configured to prevent coolant leakage and thus prevents contamination and performance degradation due to coolant leakage, and a fuel cell stack including the same.

### Background

As is known, a fuel cell stack is a kind of power generator that converts chemical energy of fuel into electric energy. The fuel cell stack generates electric energy using electrochemical reaction between fuel and air, and a coolant is circulated inside to dissipate the heat generated.

Generally, under high temperature and high output conditions during operation of the fuel cell stack, a coolant is instantly circulated at high pressure in the fuel cell stack. As such, the airtight structure of a cooling line (i.e., a coolant flow path) provided in the fuel cell stack may be destroyed in a short time, and in this case, the coolant may leak from the coolant flow path, flowing toward the reaction surface of the fuel cell stack (i.e., the catalyst layer of the membrane-electrode assembly) or flowing out of the fuel cell stack.

The coolant having leaked from the coolant flow path contaminates the inside and outside of the fuel cell stack, and also causes problems such as contamination of and damage to parts of a vehicle to which the fuel cell stack is mounted. Moreover, internal contamination of the fuel cell stack causes performance degradation of the fuel cell stack.

### SUMMARY OF THE DISCLOSURE

Therefore, the present disclosure has been made keeping in mind the problems encountered in the related art, and an object of the present disclosure is to provide a unit fuel cell with a coolant leakage prevention structure capable of preventing the inside and/or outside of the fuel cell stack from being contaminated by a coolant having leaked from a coolant flow path, and a fuel cell stack including the same.

The objects of the present disclosure are not limited to the foregoing, and other objects of the present disclosure not mentioned above will be clearly understood by those skilled in the art from the following description.

In order to accomplish the above objects, the present disclosure provides a unit fuel cell comprising a membrane-electrode assembly, a pair of separators stacked on both surfaces of the membrane-electrode assembly, a pair of coolant flow paths extending through the membrane-electrode assembly and the separators, and a pair of coolant recovery flow paths also extending through the membrane-electrode assembly and the separators, spaced apart from the coolant flow paths by a predetermined distance.

Each of the coolant flow paths may comprise a coolant flow hole formed in the separator and a coolant through-hole formed in the membrane-electrode assembly, configured to communicate with the coolant flow hole. Similarly, each of the coolant recovery flow paths may comprise a coolant recovery hole formed in the separator and a coolant discharge hole formed in the membrane-electrode assembly, configured to communicate with the coolant recovery hole. A surface of the separator may be provided with a first gasket extending along the circumference of the coolant flow hole and a second gasket disposed at a predetermined distance from the first gasket, with the second gasket positioned opposite the first gasket relative to the coolant recovery hole. The separator may also comprise a fuel flow hole and an air flow hole disposed on both sides of the coolant flow hole. The first gasket may include a fuel gasket line extending along the circumference of the fuel flow hole, an air gasket line extending along the circumference of the air flow hole, and a coolant gasket line extending along the circumference of the coolant flow hole. The second gasket may have a first end connected to the fuel gasket line and a second end connected to the air gasket line. The coolant recovery hole may extend along the coolant gasket line and be located between the first gasket and the second gasket. A hydrophobic coating layer may be provided on an outer surface of the separator, positioned between the first gasket and the second gasket.

In some embodiments, a fuel cell stack comprises a plurality of unit fuel cells, each unit fuel cell containing a membrane-electrode assembly, a pair of separators stacked on both surfaces of the membrane-electrode assembly, a pair of coolant flow paths, and a pair of coolant recovery flow paths, both sets of paths extending through the membrane-electrode assembly and the separators, with the recovery paths spaced apart from the coolant flow paths by a predetermined distance.

The pair of coolant recovery flow paths may be provided at both outer portions of the unit fuel cell and may be connected to allow coolant to flow through a bridge flow path provided outside the unit fuel cell. Air pressure may be selectively supplied to a first coolant recovery flow path among the pair of coolant recovery flow paths, while a second coolant recovery flow path may be connected to a coolant reservoir. The first coolant recovery flow path may be equipped with a first valve configured to open or close its inlet, and the second coolant recovery flow path may be equipped with a second valve configured to open or close its outlet. The first valve and the second valve may operate in a closed mode during the operation of the fuel cell stack and switch to an open mode when the operation of the fuel cell stack is terminated.

In some embodiments, a fuel cell system comprises a fuel cell stack that includes a plurality of unit fuel cells, each unit fuel cell comprising a membrane-electrode assembly, a pair of separators stacked on both surfaces of the membrane-electrode assembly, a pair of coolant flow paths extending through the membrane-electrode assembly and the separators, and a pair of coolant recovery flow paths extending through the membrane-electrode assembly and the separators, spaced apart from the coolant flow paths.

The system includes a coolant reservoir connected to the pair of coolant recovery flow paths to collect coolant that has leaked from the coolant flow paths and a pair of valves configured to control the flow of coolant through the recovery flow paths, with the first valve controlling the inlet of the first coolant recovery flow path and the second valve controlling the outlet of the second coolant recovery flow path. The pair of valves may operate in a closed mode during the operation of the fuel cell stack and switch to an open mode to discharge coolant from the recovery paths to the reservoir when the operation is terminated. The coolant recovery flow paths may be connected by a bridge flow path provided outside the unit fuel cell to allow coolant to flow between the recovery paths. The coolant recovery flow paths may be positioned at both outer portions of the unit fuel cell and configured to collect and channel leaked coolant away from the membrane-electrode assembly. The separators of the unit fuel cells may be equipped with a hydrophobic coating layer on their outer surfaces, with the coating layer positioned between the first gasket and the second gasket. The coolant recovery flow paths may be inclined at a predetermined angle to facilitate the gravitational flow of coolant toward the reservoir, and they may be configured to collect coolant during the operation of the fuel cell stack and discharge the collected coolant when the operation is terminated.

As discussed, the method and system suitably include use of a controller or processer. In another embodiment, vehicles are provided that comprise an apparatus as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 is a cross-sectional view showing a fuel cell stack according to an embodiment of the present disclosure;

FIG. 2 shows a unit fuel cell according to an embodiment of the present disclosure when viewed from the cooling surface of a separator;

FIG. 3 is a cross-sectional view showing a fuel cell stack according to another embodiment of the present disclosure;

FIG. 4 shows a unit fuel cell according to another embodiment of the present disclosure when viewed from the cooling surface of a separator;

FIG. 5 is a cross-sectional view showing a fuel cell stack according to still another embodiment of the present disclosure;

FIG. 6 shows a connection structure between a fuel cell stack and a coolant reservoir according to an embodiment of the present disclosure;

FIG. 7 shows a connection structure between a fuel cell stack and a coolant reservoir according to another embodiment of the present disclosure; and

FIG. 8 shows the configuration of a fuel cell stack according to yet another embodiment of the present disclosure.

### DETAILED DESCRIPTION OF EMBODIMENTS

Hereinafter, embodiments of the present disclosure will be described with reference to the attached drawings. Matters included in the attached drawings are depicted to easily explain embodiments of the present disclosure and may differ from the actual implementation form.

It will be understood that, although terms such as “first”, “second”, etc. may be used herein to describe various elements, these elements are not to be limited by these terms. These terms are only used to distinguish one element from another element. For instance, a “first” element” could be termed a “second” element without departing from the scope of the present disclosure, and a “second” element could also be termed a “first” element.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present disclosure provides a fuel cell stack configured to prevent the inside and/or outside of the fuel cell stack from being contaminated by a coolant having leaked from a coolant flow path (i.e., a coolant circulation line) during operation of the fuel cell stack.

Airtightness of the coolant circulation line may be temporarily destroyed in a short time when the coolant is instantaneously circulated at high pressure during operation of the fuel cell stack, and in this case, inside and/or outside of the fuel cell stack may be contaminated by the coolant having leaked from the coolant circulation line.

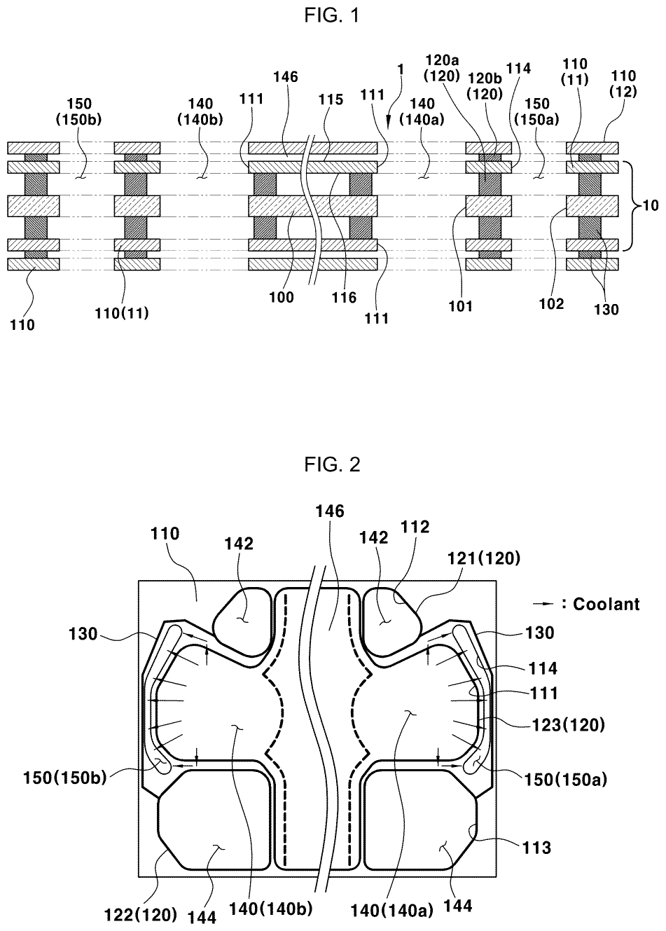

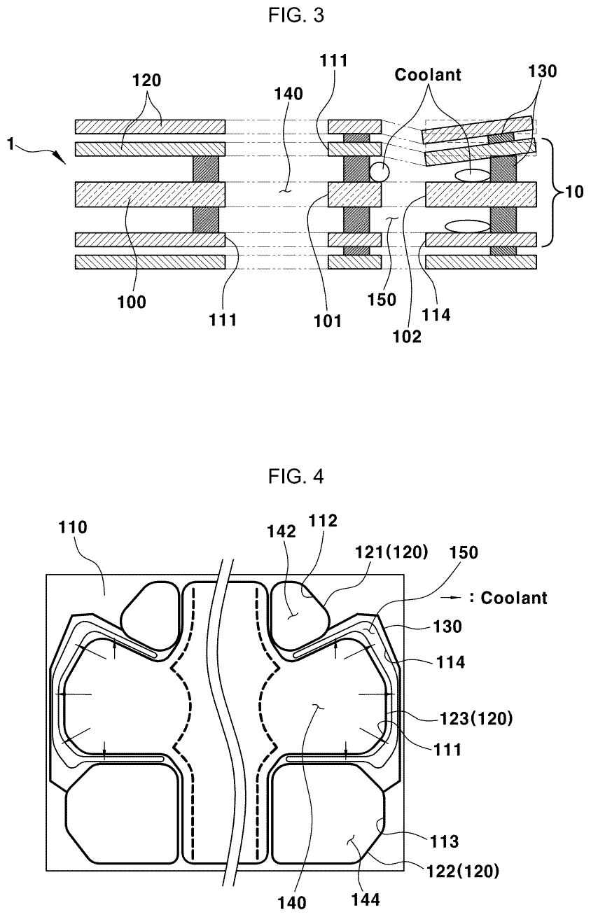

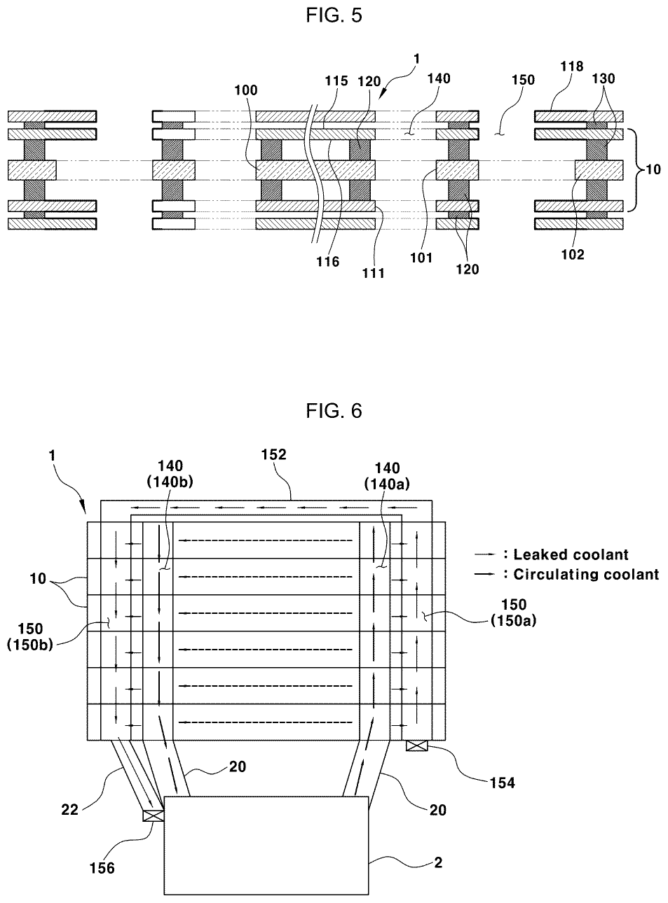

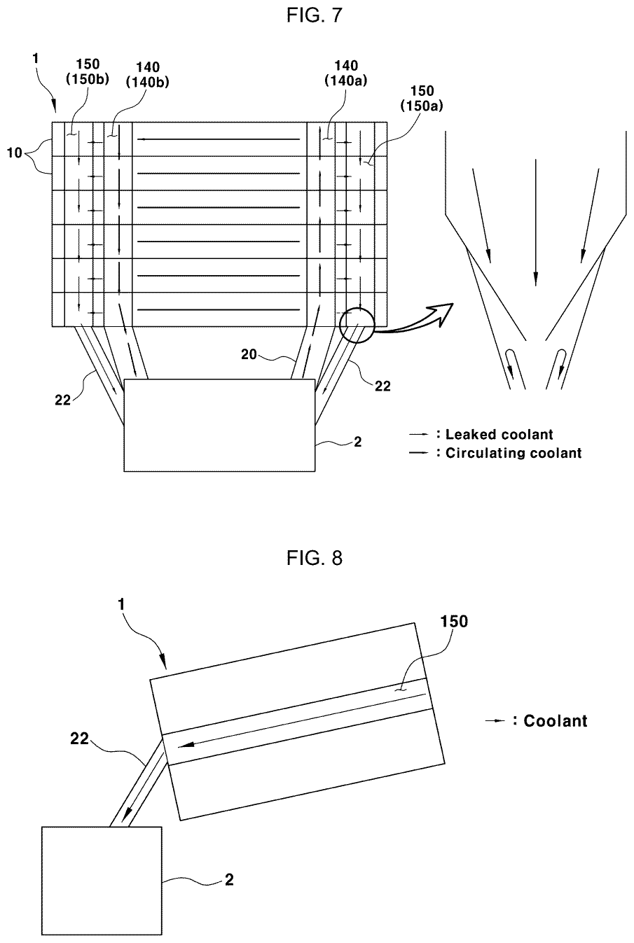

FIG. 1 is a cross-sectional view showing a fuel cell stack according to an embodiment of the present disclosure, FIG. 2 shows a unit fuel cell according to an embodiment of the present disclosure when viewed from the cooling surface of a separator, FIG. 3 is a cross-sectional view showing a fuel cell stack according to another embodiment of the present disclosure, FIG. 4 shows a unit fuel cell according to another embodiment of the present disclosure when viewed from the cooling surface of a separator, and FIG. 5 is a cross-sectional view showing a fuel cell stack according to still another embodiment of the present disclosure. Also, FIG. 6 shows a connection structure between a fuel cell stack and a coolant reservoir according to an embodiment of the present disclosure, FIG. 7 shows a connection structure between a fuel cell stack and a coolant reservoir according to another embodiment of the present disclosure, and FIG. 8 shows the configuration of a fuel cell stack according to yet another embodiment of the present disclosure.

Referring to FIG. 6, the fuel cell stack 1 according to an embodiment of the present disclosure includes a plurality of unit fuel cells 10 stacked in a row. The unit fuel cell 10 may refer to a unit cell for a fuel cell.

As shown in FIG. 2, each unit fuel cell 10 includes a membrane-electrode assembly (MEA) 100 and a pair of separators 110 stacked on both surfaces of the membrane-electrode assembly 100.

The membrane-electrode assembly 100 has a reaction surface (i.e., a catalyst layer) causing electrochemical reaction. The membrane-electrode assembly 100 is configured to cause electrochemical reaction between air and fuel supplied to the unit fuel cell 10, generating electric energy by such electrochemical reaction. The fuel may be hydrogen gas.

Although not specifically shown, the membrane-electrode assembly 100 may have a general membrane-electrode assembly structure. For example, the membrane-electrode assembly 100 may be configured to include an electrolyte membrane and a pair of catalyst layers provided on both sides of the electrolyte membrane. Here, the pair of catalyst layers may serve to cause electrochemical reaction between air and fuel, and may be referred to as an air electrode and a fuel electrode, respectively. Also, the membrane-electrode assembly 100 may further include a sub gasket provided around the electrolyte membrane and the catalyst layers. Here, the sub gasket may be provided at an outer portion of the membrane-electrode assembly 100 and stacked on a main gasket 120 and an additional gasket 130.

Also, the unit fuel cell 10 may further include components of a general unit fuel cell. For example, the unit fuel cell 10 may further include general components of a unit fuel cell, such as a gas diffusion layer for diffusion of fuel or air, etc. Here, the gas diffusion layer may be stacked between the membrane-electrode assembly 100 and the separator 110.

As shown in FIGS. 1 and 2, each separator 110 includes a coolant flow hole 111 for coolant flow, a fuel flow hole 112 for fuel flow, and an air flow hole 113 for air flow in both outer portions thereof.

Here, the coolant flow hole 111 is provided in each of both outer portions of the separator 110. The fuel flow hole 112 and the air flow hole 113 are also provided in each of both outer portions of the separator 110. Also, the fuel flow hole 112 and the air flow hole 113 are disposed at a predetermined distance in both sides of the coolant flow hole 111.

The coolant for cooling the fuel cell stack 1 circulates inside of the fuel cell stack 1 (e.g., a coolant channel, etc.) while penetrating the separator 110 through the coolant flow hole 111, and fuel and air for generating electric energy of the fuel cell stack 1 are supplied to the membrane-electrode assembly 100 while penetrating the separator 110 through the fuel flow hole 112 and the air flow hole 113, respectively.

The first separator, which is one of the pair of separators 110, may be called a cathode separator, and the second separator, which is the remaining one, may be called an anode separator. More specifically, the unit fuel cell 10 is configured to include the cathode separator, the anode separator, and the membrane-electrode assembly 100 stacked therebetween. In addition, a plurality of unit fuel cells 10 is stacked so that the cathode separator of the first unit fuel cell 11 and the anode separator of the second unit fuel cell 12 are in contact with each other. Here, a coolant channel 146 (FIG. 1) for coolant flow is provided between the cathode separator and the anode separator.

The fuel cell stack 1 includes a pair of coolant flow paths 140 and a pair of coolant recovery flow paths 150. The pair of coolant flow paths 140 and the pair of coolant recovery flow paths 150 both extend in the stacking direction of the unit fuel cells 10. The coolant flow paths 140 and the coolant recovery flow paths 150 extend to penetrate the unit fuel cell 10. Specifically, the coolant flow paths 140 and the coolant recovery flow paths 150 extend to penetrate the membrane-electrode assembly 100 and the separator 110.

Each of the coolant flow paths 140 includes a coolant flow hole 111 provided in the separator 110 and a coolant through-hole 101 provided in the membrane-electrode assembly 100 and configured to communicate with the coolant flow hole 111. The coolant flow hole 111 and the coolant through-hole 101 are located in a straight line extending in the stacking direction of the unit fuel cells 10. Specifically, the coolant flow hole 111 and the coolant through-hole 101 are stacked in the same direction as the stacking direction of the unit fuel cells 10 and are adjacent to each other.

The separator 110 includes a pair of coolant flow holes 111, and the membrane-electrode assembly 100 includes a pair of coolant through-holes 101. The pair of coolant flow holes 111 is provided in both outer portions of the separator 110, and the pair of coolant through-holes 101 is provided in both outer portions of the membrane-electrode assembly 100.

Meanwhile, the pair of coolant flow paths 140 is connected to allow the coolant to flow through the coolant channel 146. The coolant supplied to the first coolant flow path 140a among the pair of coolant flow paths 140 is moved to the second coolant flow path 140b through the coolant channel 146, and is discharged to the outside (i.e., a coolant reservoir) of the fuel cell stack 1 through the second coolant flow path 140b. The first coolant flow path 140a receives the coolant stored in the coolant reservoir 2. Herein, the coolant flow path 140 may also be referred to as a coolant circulation flow path for circulating the coolant. The coolant reservoir 2 may be connected to the first coolant flow path 140a and the second coolant flow path 140b through the coolant circulation line 20.

In addition, each of the coolant recovery flow paths 150 includes a coolant recovery hole 114 formed in the separator 110 and a coolant discharge hole 102 formed in the membrane-electrode assembly 100 and configured to communicate with the coolant recovery hole 114. The coolant recovery hole 114 and the coolant discharge hole 102 are located in a straight line extending in the stacking direction of the unit fuel cells 10. Specifically, the coolant recovery hole 114 and the coolant discharge hole 102 are stacked in the same direction as the stacking direction of the unit fuel cells 10 and are adjacent to each other.

The separator 110 has a pair of coolant recovery holes 114, and the membrane-electrode assembly 100 has a pair of coolant discharge holes 102. The pair of coolant recovery holes 114 is provided in both outer portions of the separator 110, and the pair of coolant discharge holes 102 is provided in both outer portions of the membrane-electrode assembly 100.

The pair of coolant recovery flow paths 150 is separate flow paths from the coolant flow paths 140, and is configured to enable inflow of the coolant having leaked from the coolant flow paths 140 (“leaked coolant” in FIG. 6). The coolant recovery flow paths 150 are disposed at a predetermined distance from the coolant flow paths 140. In FIGS. 6 and 7, the flows of a circulating coolant and a leaked coolant are indicated by arrows. The circulating coolant is a coolant that circulates the inside of the fuel cell stack 1 through the coolant flow paths 140, and the leaked coolant is a coolant that leaks from the coolant flow paths 140 and is collected in the coolant recovery flow paths 150.

Likewise, the coolant recovery hole 114 is a separate hole from the coolant flow hole 111, and there is a predetermined gap between the coolant recovery hole 114 and the coolant flow hole 111. Also, the coolant discharge hole 102 is a separate hole from the coolant through-hole 101, and there is a predetermined gap between the coolant discharge hole 102 and the coolant through-hole 101.

Referring to FIG. 6, the pair of coolant recovery flow paths 150 is disposed at both outer portions of the unit fuel cell 10. The coolant supplied to the first coolant recovery flow path 150a among the pair of coolant recovery flow paths 150 may be moved to the second coolant recovery flow path 150b. To this end, a bridge flow path 152 is provided outside the unit fuel cell 10 and the fuel cell stack 1 to connect the first coolant recovery flow path 150a and the second coolant recovery flow path 150b. The coolant flowing into the first coolant recovery flow path 150a may be moved to the second coolant recovery flow path 150b through the bridge flow path 152.

Referring to FIGS. 1 and 2, both the main gasket 120 and the additional gasket 130 are provided to both surfaces of the separator 110. The main gasket 120 extends along the circumference of the coolant flow hole 111, and the additional gasket 130 is disposed at a predetermined distance from the main gasket 120. The additional gasket 130 is disposed opposite the main gasket 120 with respect to the coolant recovery hole 114.

The coolant flow hole 111 and the coolant through-hole 101 forming the coolant flow path 140 are in airtight communication with each other through the main gasket 120.

Herein, respective surfaces of the separator 110 may be referred to as a reaction surface (i.e., a separator reaction surface) and a cooling surface (i.e., a separator cooling surface). The separator cooling surface 115 faces the separator cooling surface of another unit fuel cell, and the separator reaction surface 116 faces one surface (i.e., a reaction surface) of the membrane-electrode assembly 100.

Accordingly, as the separator 110 is stacked on the reaction surface of the membrane-electrode assembly 100, the first main gasket 120a is stacked and disposed between the separator 110 and the membrane-electrode assembly 100. Also, when stacking the unit fuel cells 10, the second main gasket 120b is stacked and disposed between the separator 110 of the first unit fuel cell 11 and the separator 110 of the second unit fuel cell 12.

Referring to FIG. 2, the main gasket 120 includes a fuel gasket line 121, an air gasket line 122, and a coolant gasket line 123. The fuel gasket line 121 extends and is disposed along the circumference of the fuel flow hole 112, the air gasket line 122 extends and is disposed along the circumference of the air flow hole 113, and the coolant gasket line 123 extends and is disposed along the circumference of the coolant flow hole 111. Although not specifically shown, the second main gasket 120b may further include a gasket line configured to form the coolant channel 146.

Referring to FIG. 1, the second main gasket 120b is provided to the separator cooling surface 115, and the first main gasket 120a is provided to the separator reaction surface 116. As shown in FIG. 2, the fuel gasket line 121 and the air gasket line 122 of the second main gasket 120b extend in a closed loop form, and one side of the coolant gasket line 123 of the second main gasket 120b extends in a partially open form.

Specifically, for the coolant gasket line 123 of the second main gasket 120b, the first section communicating with the coolant channel 146 extends in a partially closed form and the second section that is not in communication with the coolant channel 146 extends in a completely closed form.

Although not specifically shown, referring to FIG. 1, the coolant gasket line 123 of the first main gasket 120a has no section in communication with the coolant channel 146 and extends in a closed loop form to completely surround the entire circumference of the coolant flow hole 111. Also, although not specifically shown, the fuel gasket line 121 of the first main gasket 120a may include a partially closed section and a completely closed section to connect a fuel flow path 142 and a fuel channel (not shown) provided to the separator reaction surface 116, and the air gasket line 122 of the first main gasket 120a may include a partially closed section and a completely closed section to connect an air flow path 144 and an air channel (not shown) provided to the separator reaction surface 116.

Here, the fuel flow path 142 is a flow path including the fuel flow hole 112, and the air flow path 144 is a flow path including the air flow hole 113.

Also, as shown in FIG. 1, the coolant gasket line 123 of the first main gasket 120a extends and is disposed in a closed loop form along the circumference of the coolant through-hole 101.

Referring to FIG. 2, the additional gasket 130 has a first end connected to the fuel gasket line 121 and a second end connected to the air gasket line 122. The first end of the additional gasket 130 is directly connected to the fuel gasket line 121 in an airtight manner, and the second end of the additional gasket 130 is directly connected to the air gasket line 122 in an airtight manner.

Also, in the embodiment of FIG. 2, the coolant recovery hole 114 and the coolant discharge hole 102 extend along the coolant gasket line 123 and the additional gasket 130, and are located between the main gasket 120 and the additional gasket 130. The coolant recovery hole 114 and the coolant discharge hole 102 are in airtight communication with each other through the main gasket 120 and the additional gasket 130.

Referring to the embodiment of FIG. 4, when the coolant recovery hole 114 is formed in the separator 110, it may further extend from a region between the main gasket 120 and the additional gasket 130 to a region between the coolant flow path 140 and the air flow path 144, and also may further extend to a region between the coolant flow path 140 and the fuel flow path 142.

More specifically, there is an empty space (i.e., a portion where the gasket is not stacked) between the fuel gasket line 121 and the coolant gasket line 123 and between the air gasket line 122 and the coolant gasket line 123. The coolant recovery hole 114 may extend to such an empty space. In other words, the coolant recovery hole 114 may extend to and may be disposed between the fuel gasket line 121 and the coolant gasket line 123 and between the air gasket line 122 and the coolant gasket line 123.

Regardless of the extension length and size of the coolant recovery hole 114, the coolant having leaked from the coolant flow path 140 may be guided and moved toward the coolant recovery flow path 150, which forms a relatively low pressure at the outer portion of the separator 110 (indicated by the arrow in FIG. 2).

Referring to the embodiment of FIG. 5, a hydrophobic coating layer 118 made of a hydrophobic material is provided between the main gasket 120 and the additional gasket 130. The hydrophobic coating layer 118 is formed on the outer surface of the separator 110, and is provided only on a portion of the outer surface of the separator 110 (i.e., a region between the main gasket 120 and the additional gasket 130).

The hydrophobic coating layer 118 serves to prevent the coolant from adhering to the surface of the separator 110 by a difference in properties between the coolant and the hydrophobic material and induces the same to flow efficiently into the coolant recovery flow path 150.

Referring to FIG. 1, it is advantageous for the coolant recovery flow path 150 to have a maximum width determined by less than or equal to the distance value between the coolant gasket line 123 of the main gasket 120 and the additional gasket 130.

If the width of the coolant recovery flow path 150 is smaller by at least a predetermined value than the maximum width, there is a risk that the outer portion of the separator 110 may be bent when the unit fuel cells 10 are stacked, as shown in FIG. 3. In cases in which the outer portion of the separator 110 is bent, a local surface pressure imbalance in the fuel cell stack 1 may occur, and also, some of the coolant having leaked from the coolant flow path 140 may not flow along the coolant recovery flow path 150 but may stay between the separator 110 and the outer portion of the membrane-electrode assembly 100. There is a risk that the coolant having stayed between the separator 110 and the outer portion of the membrane-electrode assembly 100 may adhere to the separator 110 and the outer portion of the membrane-electrode assembly 100 due to water evaporation.

Therefore, as shown in FIG. 1, it is advantageous to maximize the width of the coolant recovery flow path 150 within a possible range. By minimizing the space where coolant may stay in the region between the separator 110 and the outer portion of the membrane-electrode assembly 100, discharge and recovery of the coolant through the coolant recovery flow path 150 may become easier.

Meanwhile, referring to the embodiment of FIG. 6, air pressure may be selectively supplied to the first coolant recovery flow path 150a, and the coolant flowing into and collected in the first coolant recovery flow path 150a may be discharged to the outside of the fuel cell stack 1 by the air pressure. As such, the pressure value of the air pressure may be set to a pressure value for preventing damage to the fuel cell stack 1 and simultaneously discharging the coolant efficiently from the coolant recovery flow path 150.

Although not specifically shown, the air pressure may be supplied to the first coolant recovery flow path 150a through a first air blower configured to supply air to the air flow path 144 or a second air blower provided separately from the first air blower. The operation of the air blower may be controlled by a controller (not shown) configured to control the operation of the fuel cell stack 1.

A first valve 154 is provided at the inlet of the first coolant recovery flow path 150a to open or close the inlet, and a second valve 156 is provided at the outlet of the second coolant recovery flow path 150b to open or close the outlet. The inlet of the coolant recovery flow path 150 is upstream of the coolant recovery flow path 150 based on the coolant flow direction, and the outlet of the coolant recovery flow path 150 is downstream of the coolant recovery flow path 150.

In order to discharge and recover the coolant collected in the coolant recovery flow path 150, the first valve 154 and the second valve 156 are operated in a closed mode during operation of the fuel cell stack 1, and are operated in an open mode when operation of the fuel cell stack 1 is terminated. The operation of the first valve 154 and the second valve 156 may be controlled by the controller. When the operation of the fuel cell stack 1 is terminated, the coolant circulation in the coolant flow path 140 is also stopped.

In order to discharge and recover the coolant collected in the coolant recovery flow path 150, air pressure supplied to the first coolant recovery flow path 150a is applied for a predetermined period of time, and when supply of air pressure is stopped, the valves 154, 156 are returned to the closed mode and maintained in the closed mode until the next operation of the fuel cell stack 1 begins and ends.

The second coolant recovery flow path 150b may be connected to the coolant reservoir 2 to allow the coolant to flow through the second valve 156 and a separate coolant recovery line 22. When the first valve 154 and the second valve 156 are in an open mode, the coolant in the first coolant recovery flow path 150a is moved to the second coolant recovery flow path 150b through the bridge flow path 152, and the coolant collected in the second coolant recovery flow path 150b is moved to the coolant reservoir 2.

The coolant for cooling the fuel cell stack 1 is stored in the coolant reservoir 2, and the coolant discharged from the coolant recovery flow path 150 and recovered to the coolant reservoir 2 may be recycled for the purpose of being supplied to the coolant flow path 140.

Also, when the fuel cell stack 1 is mounted to a vehicle, the coolant in the coolant recovery flow path 150 may be discharged to the coolant reservoir 2 due to running vibration of the vehicle. Therefore, as shown in the embodiment of FIG. 7, no application of the air blower configured to supply air pressure to the coolant recovery flow path 150 and the valves 154, 156 configured to open and close the inlet and outlet of the coolant recovery flow path 150 is also possible. As such, the outlet of the coolant recovery flow path 150 may be provided in a trap-type structure or a tapered form in the direction for discharging the coolant.

Also, as shown in the embodiment of FIG. 8, the coolant recovery flow path 150 may have a predetermined inclination. To this end, the fuel cell stack 1 may be disposed in the vehicle at a predetermined inclination. As such, the coolant collected in the coolant recovery flow path 150 may be discharged to the outside of the fuel cell stack 1 by gravity and recovered to the coolant reservoir 2. Moreover, when the fuel cell stack 1 is located above the coolant reservoir 2, the coolant recovery line 22 connecting the coolant recovery flow path 150 and the coolant reservoir 2 may be disposed at a predetermined inclination.

Meanwhile, in the embodiment of the present disclosure, the coolant recovery hole 114 extends long in a linear shape along the additional gasket 130, but the shape of the coolant recovery hole 114 is not necessarily limited to the linear shape. The coolant recovery hole 114 may have any shape so long as it has a structure for efficient inflow of the coolant having leaked from the coolant flow path 140. Referring to the embodiment of FIG. 2, the coolant recovery hole 114 extends continuously in the longitudinal direction of the additional gasket 130, but may also extend in a partially disconnected form if easy inflow of the coolant is possible.

Also, herein, the flow paths provided in the fuel cell stack 1 are formed by stacking unit fuel cells 10. Therefore, herein, the coolant flow path 140, the fuel flow path 142, the air flow path 144, the coolant recovery flow path 150, etc. of the unit fuel cell 10 are indicated and described by the same terms and the same reference numerals as the coolant flow path 140, the fuel flow path 142, the air flow path 144, the coolant recovery flow path 150, etc. of the fuel cell stack 1.

Furthermore, herein, the main gasket 120 may be referred to as a first gasket, and the additional gasket 130 may be referred to as a second gasket.

As is apparent from the above description, the present disclosure provides the following effects.

First, a structure configured to prevent a coolant having leaked from the coolant flow path of a fuel cell stack from flowing to the inside and/or outside of the fuel cell stack is provided, thereby preventing the leaked coolant from contaminating the inside and/or outside of the fuel cell stack.

Second, a structure configured to recover the coolant discharged from a coolant recovery flow path to a coolant reservoir when operation of the fuel cell stack is terminated is provided, thereby reducing coolant loss by recovery of the coolant having leaked from the coolant flow path.

Third, the reaction surface of the fuel cell stack and adjacent parts of a vehicle to which the fuel cell stack is mounted can be prevented from being contaminated by the coolant having leaked to outside the coolant flow path, thereby preventing performance of the fuel cell stack and function of the adjacent parts from being degraded due to contamination.

The effects of the present disclosure are not limited to the foregoing, and other effects of the present disclosure not mentioned herein will be clearly understood by those skilled in the art from the following description.

As the embodiments of the present disclosure have been described in detail above, the terms used in the specification and claims should not be construed as limited to their ordinary or dictionary meanings, and the scope of rights of the present disclosure is not limited to the aforementioned embodiments, and various modifications and improvements made by those skilled in the art using the basic concept of the present disclosure defined in the following claims are also included in the scope of the present disclosure.

What is claimed is:

1. A unit fuel cell, comprising:
a membrane-electrode assembly;
a pair of separators stacked on both surfaces of the membrane-electrode assembly;
a pair of coolant flow paths extending to penetrate the membrane-electrode assembly and the separators; and
a pair of coolant recovery flow paths extending to penetrate the membrane-electrode assembly and the separators and spaced apart from the coolant flow paths by a predetermined distance.

2. The unit fuel cell of claim 1, wherein:
each of the coolant flow paths comprises a coolant flow hole formed in the separator and a coolant through-hole formed in the membrane-electrode assembly and configured to communicate with the coolant flow hole, and
each of the coolant recovery flow paths comprises a coolant recovery hole formed in the separator and a coolant discharge hole formed in the membrane-electrode assembly and configured to communicate with the coolant recovery hole.

3. The unit fuel cell of claim 2, wherein a surface of the separator is provided with a first gasket extending along a circumference of the coolant flow hole and a second gasket disposed at a predetermined distance from the first gasket, and the second gasket is provided opposite the first gasket with respect to the coolant recovery hole.

4. The unit fuel cell of claim 3, wherein the separator comprises a fuel flow hole and an air flow hole disposed in both sides of the coolant flow hole.

5. The unit fuel cell of claim 4, wherein the first gasket comprises:
a fuel gasket line extending along a circumference of the fuel flow hole;
an air gasket line extending along a circumference of the air flow hole; and
a coolant gasket line extending along a circumference of the coolant flow hole.

6. The unit fuel cell of claim 5, wherein the second gasket comprises a first end connected to the fuel gasket line and a second end connected to the air gasket line.

7. The unit fuel cell of claim 5, wherein the coolant recovery hole extends along the coolant gasket line and is located between the first gasket and the second gasket.

8. The unit fuel cell of claim 3, wherein a hydrophobic coating layer is provided on an outer surface of the separator, and the hydrophobic coating layer is disposed between the first gasket and the second gasket.

9. A fuel cell stack comprising a plurality of the unit fuel cells of claim 1.

10. The fuel cell stack of claim 9, wherein the pair of coolant recovery flow paths is provided at both outer portions of the unit fuel cell, and is connected to allow a coolant to flow through a bridge flow path provided outside the unit fuel cell.

11. The fuel cell stack of claim 9, wherein air pressure is selectively supplied to a first coolant recovery flow path among the pair of coolant recovery flow paths, and a second coolant recovery flow path is connected to a coolant reservoir.

12. The fuel cell stack of claim 11, wherein the first coolant recovery flow path is provided with a first valve configured to open or close an inlet thereof, and the second coolant recovery flow path is provided with a second valve configured to open or close an outlet thereof.

13. The fuel cell stack of claim 12, wherein the first valve and the second valve are operated in a closed mode during operation of the fuel cell stack, and are operated in an open mode when operation of the fuel cell stack is terminated.

14. A fuel cell system comprising:
a fuel cell stack including a plurality of unit fuel cells, each unit fuel cell comprising:
a membrane-electrode assembly;
a pair of separators stacked on both surfaces of the membrane-electrode assembly;
a pair of coolant flow paths extending to penetrate the membrane-electrode assembly and the separators; and
a pair of coolant recovery flow paths extending to penetrate the membrane-electrode assembly and the separators and spaced apart from the coolant flow paths by a predetermined distance;
a coolant reservoir connected to the pair of coolant recovery flow paths to collect coolant that has leaked from the coolant flow paths; and
a pair of valves configured to control the flow of coolant through the coolant recovery flow paths, the first valve controlling an inlet of the first coolant recovery flow path and the second valve controlling an outlet of the second coolant recovery flow path.

15. The fuel cell system of claim 14, wherein the pair of valves are configured to operate in a closed mode during operation of the fuel cell stack and in an open mode when operation of the fuel cell stack is terminated, to discharge the coolant from the coolant recovery flow paths to the coolant reservoir.

16. The fuel cell system of claim 14, wherein the pair of coolant recovery flow paths are connected by a bridge flow path provided outside the unit fuel cell to allow coolant to flow between the recovery flow paths.

17. The fuel cell system of claim 14, wherein the coolant recovery flow paths are positioned at both outer portions of the unit fuel cell and are configured to collect and channel leaked coolant away from the membrane-electrode assembly.

18. The fuel cell system of claim 14, wherein the separators of the unit fuel cells are provided with a hydrophobic coating layer on the outer surfaces, and the hydrophobic coating layer is disposed between the first gasket and the second gasket.

19. The fuel cell system of claim 14, wherein the coolant recovery flow paths are inclined at a predetermined angle to facilitate the gravitational flow of the coolant toward the coolant reservoir.

20. The fuel cell system of claim 14, wherein the coolant recovery flow paths are configured to collect coolant during operation of the fuel cell stack and discharge the collected coolant when operation is terminated.
